(19) United States
(12) Patent Application Publication
(10) Pub. No.: US 2019/0208511 A1
(43) Pub. Date: Jul. 4, 2019

(54) DATA SENDING METHOD, BASE STATION, AND COMMUNICATIONS NODE

(71) Applicant: HUAWEI TECHNOLOGIES CO., LTD., Shenzhen (CN)

(72) Inventors: Mingchao Li, Beijing (CN); Guanglin Han, Munich (DE); Xiao Xiao, Beijing (CN); Yao Hua, Shenzhen (CN)

(73) Assignee: HUAWEI TECHNOLOGIES CO., LTD., Shenzhen (CN)

(21) Appl. No.: 16/294,557

(22) Filed: Mar. 6, 2019

Related U.S. Application Data
(63) Continuation of application No. PCT/CN2016/099227, filed on Sep. 18, 2016.

(51) Int. Cl. H04W 72/04

(52) U.S. Cl. CPC H04W 72/044; H04W 88/08

(57) ABSTRACT

The present disclosure provides a data sending method, a base station, and a communications node. The sending method includes: sending, by a first communications node, first request information to a base station, where the first request information is used to request first information from the base station, and the first information is used to indicate authorization of a first resource; determining, by the first communications node, second information, where the second information is used to indicate authorization of a second resource, and the second resource is selected by the first communications node from a preset resource. The first information is allocated by the base station, the second information is determined by the communications node, and the communications node flexibly selects information for communication between communications nodes. In this way, both reliability and flexibility of the communication between the communications nodes are improved.

### CROSS-REFERENCE TO RELATED APPLICATIONS

This application is a continuation of International Application No. PCT/CN2016/099227, filed on Sep. 18, 2016, which is hereby incorporated by reference in their entireties.

### TECHNICAL FIELD

Embodiments of the present invention relate to communications systems, and in particular, to a data sending method, a base station, and a communications node.

### BACKGROUND

Device-to-device (D2D) communication, vehicle-to-vehicle (V2V) communication, vehicle-to-infrastructure (V2I) communication, and vehicle-to-pedestrian (V2P) communication are technologies of direct communication between communications nodes, and the V2V communication, the V2I communication, and the V2P communication are collectively referred to as V2X communication.

Generally, communication between communications nodes is mainly classified into two modes: a mode 1 and a mode 2. The mode 1 is a mode in which a base station allocates information such as a time-frequency resource used for communication between communications nodes to the communications node, and then the communications node communicates with another communications node by using the time-frequency resource allocated by the base station. The time-frequency resource used for communication between communications nodes in the mode 1 is scheduled based on the base station. The mode 2 is a mode in which a communications node selects, from a preset time-frequency resource pool, information such as a time-frequency resource used for communication between communications nodes, and then the communications node communicates with another communications node by using the selected time-frequency resource. The time-frequency resource used for communication between communications nodes in the mode 2 is selected by the communications node.

There is an urgent need for a technical solution that can improve flexibility of communication between communications nodes in the industry.

### SUMMARY

Embodiments of the present invention provide a data sending method, a base station, and a communications node, to improve flexibility of communication between communications nodes.

According to a first aspect, a data sending method is provided and includes: sending, by a first communications node, first request information to a base station, where the first request information is used to request first information from the base station, and the first information is used to indicate authorization of a first resource; determining, by the first communications node, second information, where the second information is used to indicate authorization of a second resource, and the second resource is selected by the first communications node from a preset resource; determining, by the first communications node, third information, where the third information includes at least one of the first information and the second information; and sending, by the first communications node, data to a second communications node by using a resource indicated by the third information.

In a possible design, the first communications node receives indication information from the base station, and the indication information is used to indicate that the first communications node supports a first mode and a second mode, where the first mode is a mode in which the first communications node sends data to the second communications node by using a resource indicated by the first information, and the second mode is a mode in which the first communications node sends data to the second communications node by using a resource indicated by the second information.

In a possible design, the first communications node determines first data, and the sending, by a first communications node, first request information to a base station includes: sending, by the first communications node, the first request information to the base station based on the first data.

In a possible design, the method further includes: determining, by the first communications node, first time; and the determining, by the first communications node, third information includes: determining, by the first communications node, the third information based on the first time.

In a possible design, before the determining, by the first communications node, the third information based on the first time, the first communications node receives the first information from the base station.

In a possible design, the determining, by the first communications node, first time includes: determining, by the first communications node, a first timer parameter, and determining, by the first communications node, the first time based on the first timer parameter; or receiving, by the first communications node, a first timer parameter from the base station, and determining, by the first communications node, the first time based on the first timer parameter; and the determining, by the first communications node, the third information based on the first time includes: if the first communications node does not receive, before the first time, the first information sent by the base station, determining, by the first communications node, that the third information is the second information; or if the first communications node receives, before the first time, the first information sent by the base station, determining, by the first communications node, that the third information is the first information.

In a possible design, the first timer parameter includes a first duration parameter; and the determining, by the first communications node, the first time based on the first timer parameter includes: determining, by the first communications node, the first time based on first start time and the first duration parameter, where the first start time is time at which the first communications node determines the first data, or the first start time is time at which the first communications node sends the first request information to the base station based on the first data.

In a possible design, the method further includes: determining, by the first communications node, a second timer parameter, and determining, by the first communications node, second time based on the second timer parameter; or receiving, by the first communications node, a second timer parameter from the base station, and determining, by the first communications node, second time based on the second timer parameter; and the determining, by the first communications node, second information includes: determining, by the first communications node, the second information at the second time.

In a possible design, the second timer parameter includes a second duration parameter; and the determining, by the first communications node, second time based on the second timer parameter includes: determining, by the first communications node, the second time based on second start time and the second duration parameter, where the second start time is the time at which the first communications node determines the first data, or the second start time is the time at which the first communications node sends the first request information to the base station based on the first data.

In a possible design, the sending, by the first communications node, the first request information to the base station based on the first data includes: sending, by the first communications node in a first transmission period, the first request information to the base station based on the first data, where the first time is k milliseconds before start time of a second transmission period, k is a positive integer, and the second transmission period is a next transmission period of the first transmission period.

In a possible design, the second start time is the same as the first start time, the second duration parameter is the same as the first duration parameter, and the second time is the same as the first time.

In a possible design, the indication information includes at least one logical channel identifier, and the at least one logical channel identifier is used to indicate at least one logical channel used for sending the data based on the at least one of the first information and the second information.

In a possible design, the first information includes a first time-frequency resource for sending the first data and a first modulation and coding scheme of the first data, and the second information includes a second time-frequency resource for sending the first data and a second modulation and coding scheme of the first data.

According to a second aspect, a first communications node is provided and includes: a sending unit, configured to send first request information to a base station, where the first request information is used to request first information from the base station, and the first information is used to indicate authorization of a first resource; and a determining unit, configured to determine second information, where the second information is used to indicate authorization of a second resource, and the second resource is selected by the first communications node from a preset resource; the determining unit is further configured to determine third information, where the third information includes at least one of the first information and the second information; and the sending unit is further configured to send data to a second communications node by using a resource indicated by the third information.

In a possible design, the first communications node further includes a receiving unit; and the receiving unit is configured to receive indication information from the base station, and the indication information is used to indicate that the first communications node supports a first mode and a second mode, where the first mode is a mode in which the first communications node sends data to the second communications node by using a resource indicated by the first information, and the second mode is a mode in which the first communications node sends data to the second communications node by using a resource indicated by the second information.

In a possible design, the determining unit is further configured to determine first data; and that the sending unit is configured to send first request information to a base station includes: instructing, by the determining unit based on the first data, the sending unit to send the first request information to the base station.

In a possible design, the determining unit is further configured to determine first time, and that the determining unit is further configured to determine third information includes: determining, by the determining unit, the third information based on the first time.

In a possible design, before the determining unit determines the third information based on the first time, the receiving unit receives the first information from the base station.

In a possible design, that the determining unit is further configured to determine first time includes: determining, by the determining unit, a first timer parameter, and determining, by the determining unit, the first time based on the first timer parameter; or the receiving unit is further configured to receive a first timer parameter from the base station, and that the determining unit is further configured to determine first time includes: determining, by the determining unit, the first time based on the first timer parameter; and the determining, by the determining unit, the third information based on the first time includes: if the receiving unit does not receive, before the first time, the first information sent by the base station, determining, by the determining unit, that the third information is the second information; or if the receiving unit receives, before the first time, the first information sent by the base station, determining, by the determining unit, that the third information is the first information.

In a possible design, the first timer parameter includes a first duration parameter; and the determining, by the determining unit, the first time based on the first timer parameter includes: determining, by the determining unit, the first time based on first start time and the first duration parameter, where the first start time is time at which the first communications node determines the first data, or the first start time is time at which the sending unit sends the first request information to the base station.

In a possible design, the determining unit determines a second timer parameter, and the determining unit determines second time based on the second timer parameter; or the receiving unit receives a second timer parameter from the base station, and the determining unit determines second time based on the second timer parameter; and the determining, by the determining unit, second information includes: determining, by the determining unit, the second information at the second time.

In a possible design, the second timer parameter includes a second duration parameter; and the determining, by the determining unit, the second time based on the second timer parameter includes: determining, by the determining unit, the second time based on second start time and the second duration parameter, where the second start time is the time at which the first communications node determines the first data, or the second start time is the time at which the sending unit sends the first request information to the base station.

In a possible design, the instructing, by the determining unit based on the first data, the sending unit to send the first request information to the base station includes: instructing, by the determining unit in a first transmission period based on the first data, the sending unit to send the first request information to the base station, where the first time is k milliseconds before start time of a second transmission period, k is a positive integer, and the second transmission period is a next transmission period of the first transmission period.

In a possible design, the second start time is the same as the first start time, the second duration parameter is the same as the first duration parameter, and the second time is the same as the first time.

In a possible design, the indication information includes at least one logical channel identifier, and the at least one logical channel identifier is used to indicate at least one logical channel used for sending the data based on the at least one of the first information and the second information.

In a possible design, the first information includes a first time-frequency resource for sending the first data and a first modulation and coding scheme of the first data, and the second information includes a second time-frequency resource for sending the first data and a second modulation and coding scheme of the first data.

In a possible design, the determining unit may be a processor, the sending unit may be a transmitter or a transceiver, and the receiving unit may be a receiver or a transceiver.

According to a third aspect, an information sending method is provided and includes: sending, by a base station, indication information to a first communications node, where the indication information is used to indicate that data can be sent based on at least one of first information and second information, the first information is used to indicate authorization of a first resource, and the second information is used to indicate authorization of a second resource; and receiving, by the base station, first request information sent by the first communications node, where the first request information is sent by the first communications node to the base station based on the data; and sending, by the base station, the first information to the first communications node based on the first request information.

In a possible design, the indication information includes at least one logical channel identifier, and the at least one logical channel identifier is used to indicate at least one logical channel used for sending the data based on the at least one of the first information and the second information.

According to a fourth aspect, a base station is provided and includes: a sending unit, configured to send indication information to a first communications node, where the indication information is used to indicate that data can be sent based on at least one of first information and second information, the first information is used to indicate authorization of a first resource, and the second information is used to indicate authorization of a second resource; a receiving unit, configured to receive first request information sent by the first communications node, where the first request information is sent by the first communications node to the base station based on the data; and a determining unit, configured to instruct, based on the first request information, the sending unit to send the first information to the first communications node.

In a possible design, the indication information includes at least one logical channel identifier, and the at least one logical channel identifier is used to indicate at least one logical channel used for sending the data based on the at least one of the first information and the second information.

In a possible design, the processing unit may be a processor, the sending unit may be a transmitter or a transceiver, and the receiving unit may be a receiver or a transceiver.

According to a fifth aspect, an embodiment of the present invention provides a computer storage medium, configured to store a computer software instruction used by the foregoing base station. The computer storage medium includes a program designed for executing the foregoing aspects.

According to a sixth aspect, an embodiment of the present invention provides a computer storage medium, configured to store a computer software instruction used by the foregoing communications node. The computer storage medium includes a program designed for executing the foregoing aspects.

According to the foregoing solutions, the communications node determines the third information, the third information includes the at least one of the first information and the second information, the first information is allocated by the base station, the second information is determined by the communications node, and the communications node flexibly selects the third information for communication between communications nodes. In this way, flexibility of the communication between the communications nodes is improved.

### BRIEF DESCRIPTION OF DRAWINGS

To describe the technical solutions in the embodiments of the present invention more clearly, the following briefly describes the accompanying drawings required for describing the embodiments or the prior art. Apparently, the accompanying drawings in the following description merely show some embodiments of the present invention, and a person of ordinary skill in the art can derive other implementations from these accompanying drawings without creative efforts. All of the embodiments or the implementations shall fall within the protection scope of the present invention.

FIG. 1 is a schematic architectural diagram of a system according to an embodiment of the present invention;

FIG. 2 shows a data sending method according to an embodiment of the present invention;

FIG. 3 shows a communications node according to an embodiment of the present invention;

FIG. 4 shows another communications node according to an embodiment of the present invention;

FIG. 5 shows a base station according to an embodiment of the present invention; and

FIG. 6 shows another base station according to an embodiment of the present invention.

### DESCRIPTION OF EMBODIMENTS

Network architectures and service scenarios that are described in the embodiments of the present invention are used to describe the technical solutions in the embodiments of the present invention more clearly, but are not intended to limit the technical solutions provided in the embodiments of the present invention. A person of ordinary skill in the art may learn that, with evolution of the network architectures and emergence of a new service scenario, the technical solutions provided in the embodiments of the present invention are also applicable to a similar technical problem.

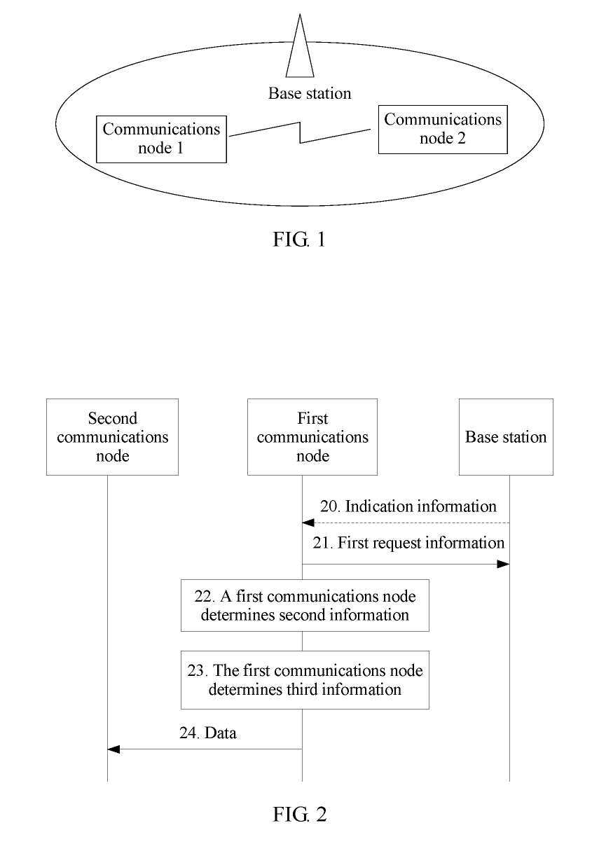

As shown in FIG. 1, a communications node 1 is a communications node that accesses a base station, and a communications node 2 is also a communications node that accesses the base station. When D2D communication or V2X communication is performed in a mode 1, the base station allocates a time-frequency resource to the communications node 1 and the communications node 2, and the communications node 1 sends data to the communications node 2 on the time-frequency resource. The mode 1 has an advantage of high reliability. However, a communications node needs to send signaling to the base station to request the base station to allocate the time-frequency resource. Therefore, the mode 1 has a disadvantage of a high delay and low flexibility. When D2D communication or V2X communication is performed in a mode 2, the communications node 1 first selects a time-frequency resource from a preset time-frequency resource pool, and then the communications node 1 sends data to the communications node 2 on the selected time-frequency resource. The mode 2 has an advantage of a low delay and high flexibility. However, different communications nodes may select a same time-frequency resource from the time-frequency resource pool for communication between communications nodes, and in this case, a conflict is caused, and reliability is relatively low.

A base station (BS) used in this application is an apparatus that is deployed in a radio access network and that is configured to provide a wireless communications service for a communications node. The base station may include a macro base station, a micro base station, a relay node, an access point, and the like that are in various forms. In systems that use different radio access technologies, names of a device that has a base station function may be different. For example, in an LTE network, the device is referred to as an evolved NodeB (eNB or eNodeB), and in 3G network, the device is referred to as a NodeB (Node B), or a road side unit (RSU) in V2V communication. For ease of description, in this application, all the foregoing apparatuses that provide a wireless communications function for the communications node are collectively referred to as a base station or a BS.

The communications node used in this application may include a handheld device, an in-vehicle device, a wearable device, a computing device or another processing device connected to a wireless modem that provides the wireless communications function, and a communications node, a mobile station (MS), a terminal, terminal equipment, user equipment (UE), or the like that is in various forms. For ease of description, in this application, the devices mentioned above are collectively referred to as a communications node.

The embodiments of the present invention are described in further detail with reference to specific examples.

FIG. 2 shows a data sending method according to an embodiment of this application, and specific steps are as follows:

Step 21: A first communications node sends first request information to a base station, and the base station receives the first request information from the first communications node. The first request information is used to request first information from the base station, and the first information is used to indicate authorization of a first resource. The first request information may be a proximity service buffer status report (ProSe BSR). After receiving the ProSe BSR sent by the first communications node, the base station allocates, based on the ProSe BSR, a resource that may be used for communication between communications nodes. Optionally, when the first communications node has no resource used to send the first request information, the first communications node first sends a scheduling request (SR) to the base station, and after receiving the scheduling request, the base station allocates, to the first communications node, the resource used to send the first request information, and the first communications node may send the first request information to the base station on the resource allocated by the base station for sending the first request information. Optionally, the first information is used to indicate the resource used by the first communications node for the communication between communications nodes. Optionally, the first information is information in a mode 1.

In an optional embodiment, the first communications node determines first data, and that a first communications node sends first request information to a base station includes: The first communications node sends the first request information to the base station based on the first data. In an optional embodiment, the first data is service data of an event trigger type. For example, in V2X communication, when a first vehicle detects that the first vehicle is to collide with another vehicle, the first vehicle needs to send information of the first vehicle or the another vehicle to the another vehicle, such as a location, a speed, and a driving direction that are of the vehicle.

Step 22: The first communications node determines second information. The second information is used to indicate authorization of a second resource, and the second resource is selected by the first communications node from a preset resource. Optionally, the second information is used to indicate the resource used by the first communications node for the communication between communications nodes. In an optional embodiment, the first communications node selects, from a preset resource pool, the resource used for the communication between communications nodes, and determines the second information based on the selected resource. Optionally, the second information is information in a mode 2. Optionally, the first communications node determines the second information based on the first data.

In an optional embodiment, the first communications node determines a second timer parameter, and the first communications node determines second time based on the second timer parameter; or the first communications node receives a second timer parameter from the base station, and the first communications node determines second time based on the second timer parameter. The first communications node determines the second information at the second time. Optionally, the second timer parameter includes a second duration parameter, and the first communications node determines the second time based on second start time and the second duration parameter. The second start time is time at which the first communications node determines the first data, or the second start time is time at which the first communications node sends the first request information to the base station.

Step 23: The first communications node determines third information, where the third information includes at least one of the first information and the second information. Optionally, the third information is used to indicate the resource used by the first communications node for the communication between communications nodes. Optionally, the third information may be the first information, or the third information may be the second information, or the third information may be the first information and the second information.

In an optional embodiment, the first communications node determines first time, and that the first communications node determines third information includes: the first communications node determines the third information based on the first time. In an optional embodiment, the first time is determined by the first communications node based on a first timer parameter, and the first timer parameter may be preset. In an optional embodiment, the first timer parameter includes a first duration parameter, and the first communications node determines the first time based on first start time and the first duration parameter. The first start time is the time at which the first communications node determines the first data, or the first start time is the time at which the first communications node sends the first request information to the base station. In an optional embodiment, the first start time is time at which the first communications node sends the scheduling request to the base station.

In an optional embodiment, the first communications node receives a first timer parameter from the base station, and the first communications node determines the first time based on the first timer parameter. In an optional embodiment, the first timer parameter includes a first duration parameter, and the first communications node determines the first time based on first start time and the first duration parameter. The first start time is the time at which the first communications node determines the first data, or the first start time is the time at which the first communications node sends the first request information to the base station.

In an optional embodiment, the second start time is the same as the first start time, the second duration parameter is the same as the first duration parameter, and the second time is the same as the first time.

In an optional embodiment, before the first communications node determines the third information based on the first time, the base station sends the first information to the first communications node, and the first communications node receives the first information from the base station. Optionally, if the first communications node receives, before the first time, the first information sent by the base station, the first communications node determines that the third information is the first information.

In an optional embodiment, after the first communications node determines the third information based on the first time, the base station sends the first information to the first communications node, and the first communications node receives the first information from the base station. Optionally, if the first communications node does not receive, before the first time, the first information sent by the base station, the first communications node determines that the third information is the second information.

Step 24: The first communications node sends data to a second communications node by using a resource indicated by the third information, and the second communications node receives the data from the first communications node by using the resource indicated by the third information. In an optional embodiment, when the third information is the first information, the first communications node may send the first data to the second communications node by using a resource indicated by the first information; or the first communications node may send the first data to the base station by using a resource indicated by the first information, and then the base station sends the first data to the second communications node. In an optional embodiment, the data sent by the first communications node to the second communications node by using the resource indicated by the third information may be the first data, or may be other data different from the first data. For example, although the first information is requested by the first communications node based on the first data and/or the second information is determined by the first communications node based on the first data, after the first communications node determines the third information, the first communications node may send the first data or second data to the second communications node by using the resource indicated by the third information, and the second data and the first data are different data.

In an optional embodiment, the first communications node sends, in a first transmission period, the first request information to the base station based on the first data. The first time is k milliseconds before start time of a second transmission period, k is a positive integer, and the second transmission period is a next transmission period of the first transmission period.

In an optional embodiment, before the first communications node determines the first data, step 20 may be included. The first communications node receives indication information from the base station, and the indication information is used to indicate that the first communications node supports a first mode (for example, the mode 1) and a second mode (for example, the mode 2). The first mode is a mode in which the first communications node sends data to the second communications node by using the resource indicated by the first information, and the second mode is a mode in which the first communications node sends data to the second communications node by using a resource indicated by the second information. Optionally, the indication information received by the first communications node from the base station includes the first timer parameter and the second timer parameter. Optionally, the indication information includes at least one logical channel identifier, and is used to indicate that the first data in a logical channel corresponding to the logical channel identifier may be sent based on at least one of the first information and the second information. Optionally, the indication information may be sent by using RRC dedicated signaling, or may be sent by using system broadcast information.

According to this embodiment of the present invention, the communications node determines the third information, the third information includes at least one of the first information and the second information, the first information is allocated by the base station, the second information is determined by the communications node, and the communications node flexibly selects information for communication between communications nodes. In this way, flexibility of the communication between the communications nodes is improved.

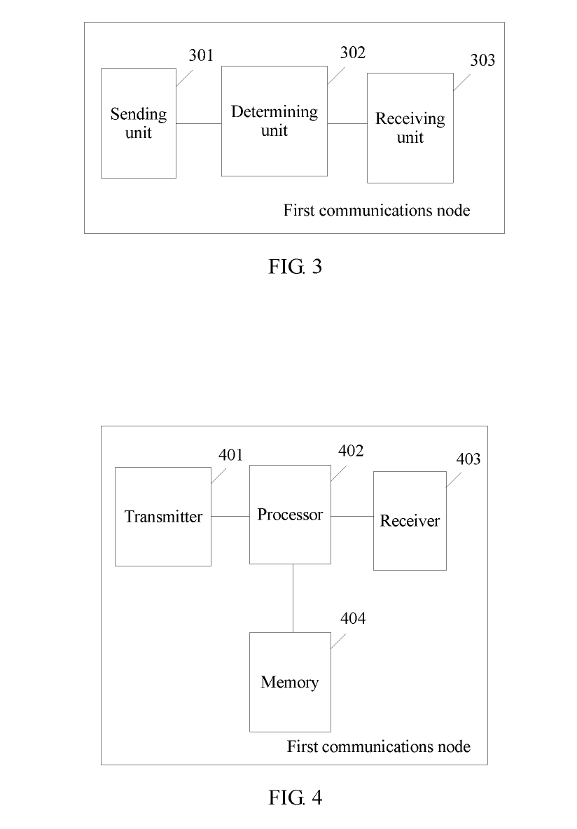

FIG. 3 is a possible schematic structural diagram of a first communications node configured to perform the method in the embodiment in FIG. 2. The communications node includes a sending unit 301 and a determining unit 302.

The sending unit 301 is configured to send first request information to a base station, where the first request information is used to request first information from the base station, and the first information is used to indicate authorization of a first resource. The first request information may be a proximity service buffer status report (ProSe BSR). After receiving the ProSe BSR sent by the first communications node, the base station allocates, based on the ProSe BSR, a resource that may be used for communication between communications nodes. Optionally, when the first communications node has no resource used to send the first request information, the sending unit 301 first sends a scheduling request (SR) to the base station, and after receiving the scheduling request, the base station allocates, to the first communications node, the resource used to send the first request information, and the sending unit 301 may send the first request information to the base station on the resource allocated by the base station for sending the first request information. Optionally, the first information is used to indicate the resource used by the first communications node for the communication between communications nodes. Optionally, the first information is information in a mode 1.

In an optional embodiment, the determining unit 302 determines first data; and that the sending unit 301 sends first request information to a base station includes: the determining unit 302 instructs, based on the first data, the sending unit 301 to send the first request information to the base station. In an optional embodiment, the first data is service data of an event trigger type. For example, in V2X communication, when a first vehicle detects that the first vehicle is to collide with another vehicle, the first vehicle needs to send information of the first vehicle or the another vehicle to the another vehicle, such as a location, a speed, and a driving direction that are of the vehicle.

The determining unit 302 is configured to determine second information, where the second information is used to indicate authorization of a second resource, and the second resource is selected by the first communications node from a preset resource. In an optional embodiment, the determining unit 302 selects, from a preset resource pool, the resource used for the communication between communications nodes, and determines the second information based on the selected resource. Optionally, the second information is information in a mode 2. Optionally, the determining unit 302 determines the second information based on the first data.

In an optional embodiment, the determining unit 302 determines a second timer parameter, and the determining unit 302 determines second time based on the second timer parameter; or the receiving unit 303 receives a second timer parameter from the base station, and the determining unit 302 determines second time based on the second timer parameter. The determining unit 302 determines the second information at the second time. Optionally, the second timer parameter includes a second duration parameter, and the determining unit 302 determines the second time based on second start time and the second duration parameter. The second start time is time at which the determining unit 302 determines the first data, or the second start time is time at which the sending unit 301 sends the first request information to the base station.

The determining unit 302 is further configured to determine third information, where the third information includes at least one of the first information and the second information. Optionally, the third information is used to indicate the resource used by the first communications node for the communication between communications nodes. Optionally, the third information may be the first information, or the third information may be the second information, or the third information may be the first information and the second information.

In an optional embodiment, the determining unit 302 determines first time, and that the determining unit 302 determines third information includes: the determining unit 302 determines the third information based on the first time. In an optional embodiment, the first time is determined by the determining unit 302 based on a first timer parameter, and the first timer parameter may be preset. In an optional embodiment, the first timer parameter includes a first duration parameter, and the determining unit 302 determines the first time based on first start time and the first duration parameter. The first start time is the time at which the determining unit 302 determines the first data, or the first start time is the time at which the sending unit 301 sends the first request information to the base station. In an optional embodiment, the first start time is time at which the sending unit 301 sends the scheduling request to the base station.

In an optional embodiment, the receiving unit 303 receives a first timer parameter from the base station, and the determining unit 302 determines the first time based on the first timer parameter. In an optional embodiment, the first timer parameter includes a first duration parameter, and the determining unit 302 determines the first time based on first start time and the first duration parameter. The first start time is the time at which the determining unit 302 determines the first data, or the first start time is the time at which the sending unit 301 sends the first request information to the base station.

In an optional embodiment, the second start time is the same as the first start time, the second duration parameter is the same as the first duration parameter, and the second time is the same as the first time.

In an optional embodiment, before the determining unit 302 determines the third information based on the first time, the base station sends the first information to the first communications node, and the receiving unit 303 receives the first information from the base station. Optionally, if the receiving unit 303 receives, before the first time, the first information sent by the base station, the determining unit 302 determines that the third information is the first information.

In an optional embodiment, after the determining unit 302 determines the third information based on the first time, the base station sends the first information to the first communications node, and the receiving unit 303 receives the first information from the base station. Optionally, if the receiving unit 303 does not receive, before the first time, the first information sent by the base station, the determining unit 302 determines that the third information is the second information.

The sending unit 301 is further configured to send data to a second communications node by using a resource indicated by the third information. In an optional embodiment, when the third information is the first information, the sending unit 301 may send the first data to the second communications node by using a resource indicated by the first information; or the sending unit 301 may send the first data to the base station by using a resource indicated by the first information, and then the base station sends the first data to the second communications node. In an optional embodiment, the data sent by the sending unit 301 to the second communications node by using the resource indicated by the third information may be the first data, or may be other data different from the first data. For example, although the first information is requested by the sending unit 301 from the base station based on the first data and/or the second information is determined by the determining unit 302 based on the first data, after the determining unit 302 determines the third information, the sending unit 301 may send the first data or second data to the second communications node by using the resource indicated by the third information, and the second data and the first data are different data.

In an optional embodiment, the determining unit 302 instructs, in a first transmission period based on the first data, the sending unit 301 to send the first request information to the base station. The first time is k milliseconds before start time of a second transmission period, k is a positive integer, and the second transmission period is a next transmission period of the first transmission period.

In an optional embodiment, before the determining unit 302 determines the first data, the receiving unit 303 may further receive indication information from the base station, and the indication information is used to indicate that the first communications node supports a first mode (for example, the mode 1) and a second mode (for example, the mode 2). The first mode is a mode in which the sending unit 301 sends data to the second communications node by using the resource indicated by the first information, and the second mode is a mode in which the sending unit 301 sends data to the second communications node by using a resource indicated by the second information. Optionally, the indication information received by the receiving unit 303 from the base station includes the first timer parameter and the second timer parameter. Optionally, the indication information includes at least one logical channel identifier, and is used to indicate that the first data in a logical channel corresponding to the logical channel identifier may be sent based on at least one of the first information and the second information. Optionally, the indication information may be sent by using RRC dedicated signaling, or may be sent by using system broadcast information.

According to this embodiment of the present invention, the communications node determines the third information, the third information includes at least one of the first information and the second information, the first information is allocated by the base station, the second information is determined by the communications node, and the communications node flexibly selects information for communication between communications nodes. In this way, flexibility of the communication between the communications nodes is improved.

In an optional embodiment, the sending unit 301 may be a transmitter 401, the processing unit 302 may be a processor 402, the receiving unit 303 may be a receiver 403, and the transmitter 401 and the receiver 403 may be replaced with a transceiver. Optionally, the communications node may further include a memory 404, and the memory 404 is configured to store program code and data of the communications node. Specifically, as shown in FIG. 4, the communications node includes the transmitter 401, the processor 402, the receiver 403, and the memory 404.

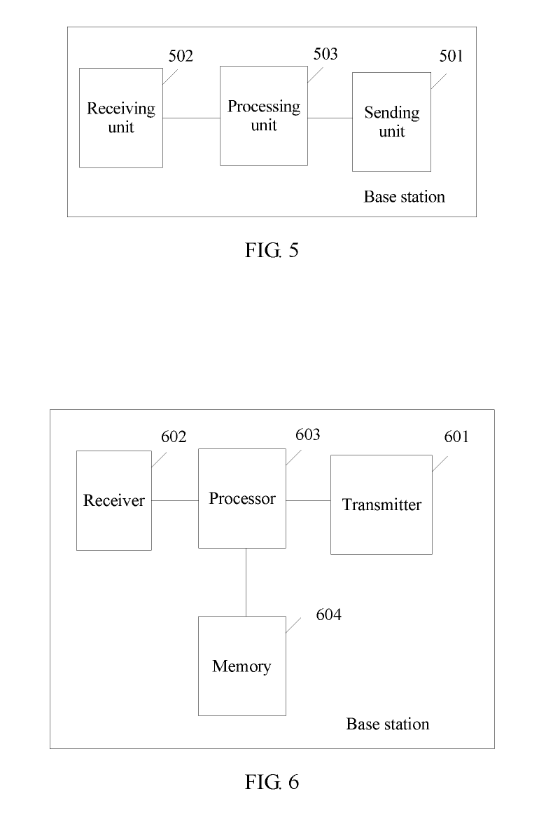

FIG. 5 is a possible schematic structural diagram of a base station configured to perform the method used in the embodiment in FIG. 2, and the base station includes a sending unit 501, a receiving unit 502, and a processing unit 503.

The sending unit 501 is configured to send indication information to a first communications node, where the indication information is used to indicate that data can be sent based on at least one of first information and second information. The first information is used to indicate authorization of a first resource, and the second information is used to indicate authorization of a second resource. The indication information is consistent with that in the embodiment in FIG. 2.

In an optional embodiment, the indication information includes at least one logical channel identifier, and the at least one logical channel identifier is used to indicate at least one logical channel used for sending the data based on the at least one of the first information and the second information.

The receiving unit 502 is configured to receive first request information sent by the first communications node, where the first request information is sent by the first communications node to the base station based on the data. The first request information is consistent with that in the embodiment in FIG. 2.

The processing unit 503 is configured to instruct, based on the first request information, the sending unit to send the first information to the first communications node. The first information is consistent with that in the embodiment in FIG. 2.

In an optional embodiment, the sending unit 501 may be a transmitter 601, the receiving unit 502 may be a receiver 602, the processing unit 503 may be a processor 603, and the transmitter 601 and the receiver 602 may be replaced with a transceiver. Optionally, the base station may further include a memory 604, and the memory 604 is configured to store program code and data of the communications node. Specifically, as shown in FIG. 6, the communications node includes the transmitter 601, the receiver 602, the processor 603, and the memory 604.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communications connections may be implemented by using some interfaces. The indirect couplings or communications connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or some of the technical solutions may be implemented in the form of a software product. The software product is stored in a storage medium and includes several instructions for instructing a computer device (which may be a personal computer, a server, or a network device) to perform all or some of the steps of the methods described in the embodiments of the present invention. The foregoing storage medium includes any medium that can store program code, such as a USB flash drive, a removable hard disk, a read-only memory (ROM), a random access memory (RAM), a magnetic disk, or an optical disc.

In a case that no conflict occurs, the embodiments in the present invention and the features in the embodiments may be mutually combined.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method of sending data, comprising:
sending, by a first communications node to a base station, first request information used to request from the base station first information used to indicate authorization of a first resource;
determining, by the first communications node, second information used to indicate authorization of a second resource selected by the first communications node from a preset resource;
determining, by the first communications node, third information comprising at least one of the first information and the second information; and
sending, by the first communications node, data to a second communications node by using a resource indicated by the third information.

2. The method according to claim 1, wherein:
the first communications node receives from the base station indication information used to indicate that the first communications node supports a first mode and a second mode, wherein the first mode is a mode in which the first communications node sends data to the second communications node by using a resource indicated by the first information, and the second mode is a mode in which the first communications node sends data to the second communications node by using a resource indicated by the second information.

3. The method according to claim 2, wherein
the indication information comprises at least one logical channel identifier used to indicate at least one logical channel used for sending the data based on the at least one of the first information and the second information.

4. The method according to claim 1, further comprising:
determining, by the first communications node, first data; and
the sending, by a first communications node, first request information to a base station comprises:
sending, by the first communications node, the first request information to the base station based on the first data.

5. The method according to claim 1, further comprising:
determining, by the first communications node, first time; and
the determining, by the first communications node, third information comprises:
determining, by the first communications node, the third information based on the first time.

6. The method according to claim 5, wherein
before the determining, by the first communications node, the third information based on the first time, the first communications node receives the first information from the base station.

7. The method according to claim 5, wherein:
the determining, by the first communications node, first time comprises: determining, by the first communications node, a first timer parameter, and determining, by the first communications node, the first time based on the first timer parameter; or receiving, by the first communications node, a first timer parameter from the base station, and determining, by the first communications node, the first time based on the first timer parameter; and
the determining, by the first communications node, the third information based on the first time comprises:
when the first communications node does not receive, before the first time, the first information sent by the base station, determining, by the first communications node, that the third information is the second information; or
when the first communications node receives, before the first time, the first information sent by the base station, determining, by the first communications node, that the third information is the first information.

8. The method according to claim 7, wherein:
the first timer parameter comprises a first duration parameter; and
the determining, by the first communications node, the first time based on the first timer parameter comprises:
determining, by the first communications node, the first time based on first start time and the first duration parameter; wherein
the first start time is time at which the first communications node determines the first data, or
the first start time is time at which the first communications node sends the first request information to the base station based on the first data.

9. The method according to claim 7, wherein the method further comprises:
determining, by the first communications node, a second timer parameter, and determining, by the first communications node, second time based on the second timer parameter; or receiving, by the first communications node, a second timer parameter from the base station, and determining, by the first communications node, second time based on the second timer parameter; and
the determining, by the first communications node, second information comprises:
determining, by the first communications node, the second information at the second time.

10. The method according to claim 9, wherein:
the second timer parameter comprises a second duration parameter; and
the determining, by the first communications node, second time based on the second timer parameter comprises:
determining, by the first communications node, the second time based on second start time and the second duration parameter; wherein
the second start time is the time at which the first communications node determines the first data, or
the second start time is the time at which the first communications node sends the first request information to the base station based on the first data.

11. The method according to claim 4, wherein:
the sending, by the first communications node, the first request information to the base station based on the first data comprises: sending, by the first communications node in a first transmission period, the first request information to the base station based on the first data; and
the first time is k milliseconds before start time of a second transmission period, k is a positive integer, and the second transmission period is a next transmission period of the first transmission period.

12. The method according to claim 10, wherein:
the second start time is the same as the first start time, the second duration parameter is the same as the first duration parameter, and the second time is the same as the first time.

13. A first communications node, comprising:
a transmitter, configured to transmit to a base station first request information to a base station used to request from the base station first information used to indicate authorization of a first resource; and
a processor, configured to determine second information used to indicate authorization of a second resource selected by the first communications node from a preset resource; wherein
the processor is further configured to determine third information comprising at least one of the first information and the second information; and
the transmitter is further configured to send data to a second communications node by using a resource indicated by the third information.

14. The first communications node according to claim 13, wherein the first communications node further comprises a receiver configured to receive from the base station indication information used to indicate that the first communications node supports a first mode and a second mode, the first mode is a mode in which the first communications node sends data to the second communications node by using a resource indicated by the first information, and the second mode is a mode in which the first communications node sends data to the second communications node by using a resource indicated by the second information.

15. The first communications node according to claim 14, wherein:
the indication information comprises at least one logical channel identifier, and the at least one logical channel identifier is used to indicate at least one logical channel used for sending the data based on the at least one of the first information and the second information.

16. The first communications node according to claim 13, wherein:
the processor is further configured to determine first time; and
the processor is further configured to determine third information comprises:
determining, by the processor, the third information based on the first time.

17. The first communications node according to claim 16, wherein:
before the processor determines the third information based on the first time, the receiver receives the first information from the base station.

18. The first communications node according to claim 16, wherein:
the processor is further configured to determine first time comprises: determining, by the processor, a first timer parameter, and determining, by the processor, the first time based on the first timer parameter; or
the receiver is further configured to receive a first timer parameter from the base station, and
the processor is further configured to determine first time comprises: determining, by the processor, the first time based on the first timer parameter; and
the determining, by the processor, the third information based on the first time comprises:
when the receiver does not receive, before the first time, the first information sent by the base station, determining, by the processor, that the third information is the second information; or
when the receiver receives, before the first time, the first information sent by the base station, determining, by the processor, that the third information is the first information.

19. A method of sending information, comprising:
sending, by a base station to a first communications node, indication information used to indicate that data can be sent based on at least one of first information and second information, the first information is used to indicate authorization of a first resource, and the second information is used to indicate authorization of a second resource;
receiving, by the base station from a communications node, first request information, wherein the first request information is sent by the first communications node to the base station based on the data; and
sending, by the base station, the first information to the first communications node based on the first request information.

20. The method according to claim 19, wherein:
the indication information comprises at least one logical channel identifier, and the at least one logical channel identifier is used to indicate at least one logical channel used for sending the data based on the at least one of the first information and the second information.
